(19) United States
(12) Patent Application Publication
(10) Pub. No.: US 2025/0346210 A1
(43) Pub. Date: Nov. 13, 2025

(54) VEHICLE WINDOW GLASS

(71) Applicant: AGC Inc., Tokyo (JP)

(72) Inventors: Shintaro KOJIMA, Tokyo (JP); Ryota NAKAYAMA, Tokyo (JP)

(73) Assignee: AGC Inc., Tokyo (JP)

(21) Appl. No.: 19/280,680

(22) Filed: Jul. 25, 2025

Related U.S. Application Data
(63) Continuation of application No. PCT/JP2024/001701, filed on Jan. 22, 2024.

(30) Foreign Application Priority Data
Jan. 26, 2023 (JP) 2023-010467

(51) Int. Cl. B60S 1/02; B60S 1/58

(52) U.S. Cl. CPC B60S 1/026; B60S 1/586

(57) ABSTRACT

A defogger includes a pair of bus bars extending in a vertical direction of a glass plate and plural heating wires, the glass plate has a first anti-fog region and a second anti-fog region surrounding a wiring prohibited region, the plural heating wires include a first heating wire, a second heating wire, and a third heating wire, the first heating wire and the second heating wire are connected to each other at connecting portions located around the wiring prohibited region, and the third heating wire has a section extending in the lateral direction below the wiring prohibited region, or the first heating wire has a section extending in the lateral direction above the wiring prohibited region, and the second heating wire and the third heating wire are connected to each other at connecting portions located around the wiring prohibited region to form a single composite heating wire.

### CROSS-REFERENCE TO RELATED APPLICATIONS

This application is a continuation application of International Application No. PCT/JP2024/001701 filed Jan. 22, 2024 the disclosure of which is incorporated herein by reference in its entirety. Further, this application claims priorities from Japanese Patent Application No. 2023-010467 filed Jan. 26, 2023, the disclosure of which is incorporated herein by reference in their entirety.

### TECHNICAL FIELD

The present disclosure relates to a vehicle window glass.

### RELATED ART

Conventionally, in a rear glass of a vehicle which is disposed inside the vehicle and in which heating wires of an antenna and a defogger are formed, as a technique for achieving both anti-fogging of an imaging range (wiring prohibited region) of an in-vehicle camera which images an outside of the vehicle through the rear glass and securing of an arrangement area of the antenna, a glass plate for a window of the vehicle, a defogger provided on the glass plate, and an antenna provided on the glass plate are provided, in which the defogger includes a pair of bus bars extending in a vertical direction of the glass plate, a first anti-fog region formed by a plurality of first heating wires connected between the pair of bus bars and extending in a lateral direction of the glass plate, and a second anti-fog region formed to surround the wiring prohibited region by at least one second heating wire connected to the pair of bus bars or the first anti-fog region and extending in one direction in the vertical direction, and the antenna is provided in at least one of a region on a left side of the second anti-fog region and a region on a right side of the second anti-fog region. A technique in which the second heating wire is formed by one-stroke writing is known (see, for example, WO 2019/017246 A (Patent Document 1)).

Incidentally, in the configuration in which at least one second heating wire surrounds the wiring prohibited region in a one-stroke manner as in the conventional vehicle window glass, there is a portion that does not surround the wiring prohibited region, so that there is room for improvement in the temperature distribution in the wiring prohibited region.

### SUMMARY

In this regard, an object is to provide a vehicle window glass having a good temperature distribution in a wiring prohibited region.

A vehicle window glass of an embodiment of the present disclosure including a glass plate having a wiring prohibited region, and a defogger provided on the glass plate, in which the defogger includes a pair of bus bars extending in a vertical direction of the glass plate, and a plurality of heating wires connected between the pair of bus bars and extending in a lateral direction of the glass plate, the glass plate includes a first anti-fog region extending in the lateral direction between the pair of bus bars, and a second anti-fog region formed to surround the wiring prohibited region, the plurality of heating wires includes a first heating wire, a second heating wire, and a third heating wire provided in the second anti-fog region, and the first heating wire and the second heating wire are connected to each other at connecting portions located around the wiring prohibited region to form a single composite heating wire, in which the composite heating wire has a section extending in the lateral direction on an upper side of the wiring prohibited region, and the third heating wire has a section extending in the lateral direction on a lower side of the wiring prohibited region, or the first heating wire has a section extending in the lateral direction on an upper side of the wiring prohibited region, and the second heating wire and the third heating wire are connected to each other at connecting portions located around the wiring prohibited region to form a single composite heating wire, in which the composite heating wire has a section extending in the lateral direction on a lower side of the wiring prohibited region.

A vehicle window glass having a good temperature distribution in a wiring prohibited region can be provided.

### BRIEF DESCRIPTION OF DRAWINGS

FIG. 1 is a plan view illustrating an example of a configuration of a vehicle window glass according to an embodiment from a viewpoint of a vehicle interior side.

FIG. 2 is an enlarged view illustrating an example of a configuration of a portion around a wiring prohibited region in an overall configuration of a vehicle window glass according to an embodiment.

FIG. 3A is a diagram illustrating an example of a simulation result of a temperature distribution in a vehicle window glass according to the embodiment.

FIG. 3B is a diagram illustrating an example of a simulation result of a temperature distribution in a vehicle window glass according to the embodiment.

FIG. 3C is a diagram illustrating an example of a simulation result of temperature distribution in a comparative vehicle window glass.

FIG. 3D is a diagram illustrating an example of a simulation result of temperature distribution in a comparative vehicle window glass.

FIG. 4A is a diagram illustrating examples of configurations of a first heating wire, a second heating wire, and a third heating wire in a second anti-fog region of a vehicle window glass according to a first modification example of the embodiment.

FIG. 4B is a diagram illustrating an example of a configuration of a vehicle window glass of a second modification example of the embodiment.

### DETAILED DESCRIPTION

### Embodiments

Hereinafter, embodiments of the present invention will be described with reference to the drawings. Note that, in each aspect, a deviation to the extent that the effect of the invention is not impaired is allowed in directions such as parallel, a right angle, horizontal, vertical, up and down, and left and right. In addition, each plan view is a view when a glass surface of a glass plate (hereinafter, also referred to as “window glass”) for a vehicle window is viewed from an opposite side, and illustrates the window glass attached to the vehicle from a viewpoint (vehicle interior view) from the vehicle interior side. In addition, in a case where the window glass is a windshield attached to the front of the vehicle or a rear glass attached to the rear of the vehicle, the vertical direction in each plan view corresponds to the vertical direction of the vehicle, and the lateral direction in each plan view corresponds to the vehicle width direction of the vehicle. In addition, the window glass is not limited to the windshield or the rear glass, and may be, for example, a side glass attached to a side portion of the vehicle. In addition, in each plan view, a direction parallel to the X axis (X-axis direction), a direction parallel to the Y axis (Y-axis direction), and a direction parallel to the Z axis (Z-axis direction) represent the lateral direction of the glass plate, the vertical direction of the glass plate, and a direction perpendicular to the surface of the glass plate (also referred to as a normal direction), respectively. The X-axis direction, the Y-axis direction, and the Z-axis direction are orthogonal to each other.

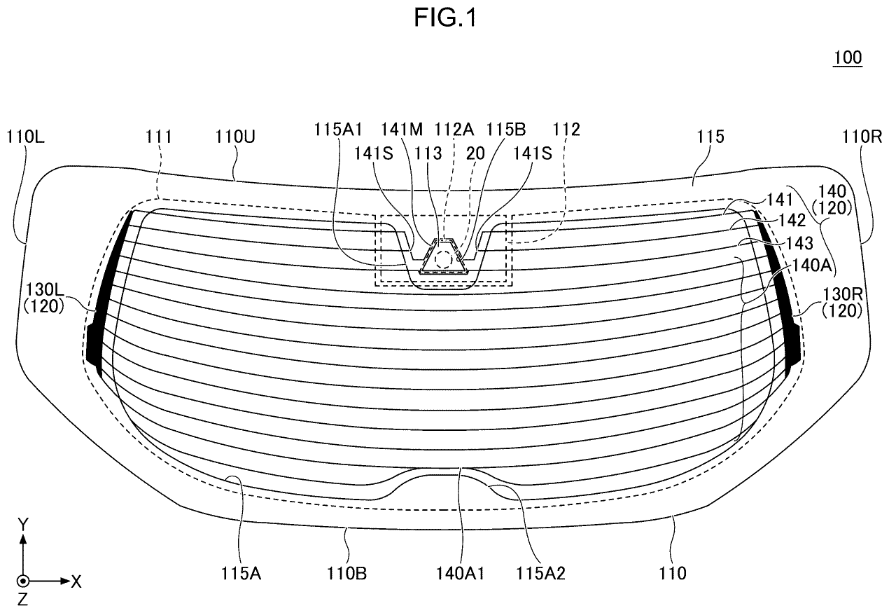

FIG. 1 is a plan view illustrating an example of the configuration of a vehicle window glass 100 as viewed from inside the vehicle. As an example, the vehicle window glass 100 has a line-symmetric configuration with a straight line passing through the center in the lateral direction in plan view in the vertical direction as a symmetry axis.

The vehicle window glass 100 illustrated in FIG. 1 is an example of a rear glass attached to a rear portion of a vehicle. The vehicle window glass 100 includes a glass plate 110 for a vehicle window and a defogger 120 provided on the glass plate 110. The defogger 120 includes bus bars 130L and 130R and a plurality of heating wires 140.

The bus bars 130L and 130R and the plurality of heating wires 140 are formed, for example, by printing and baking paste (for example, silver paste or the like) containing a conductive metal on the vehicle interior side surface of the glass plate 110. As a method for printing a paste containing a conductive metal, a screen printing method, an offset printing method, a gravure printing method, a flexographic printing method, an inkjet printing method, or the like can be used. The bus bars 130L and 130R and the plurality of heating wires 140 thus formed have substantially the same thickness. Since the thicknesses of the plurality of heating wires 140 are substantially the same, for each heating wire 140, the wider (thicker) the width (line width), the thicker each heating wire 140. The bus bars 130L and 130R and the plurality of heating wires 140 may have a thickness of 5 μm or more and 20 μm or less. Furthermore, the width of the plurality of the heating wires 140 may be 0.15 mm or more and 1.0 mm or less, or may be 0.15 mm or more and 0.5 mm or less.

The method for forming the bus bars 130L and 130R and the plurality of heating wires 140 is not limited to the above method. For example, the bus bars 130L and 130R and the plurality of heating wires 140 may be formed by providing a linear body or a foil-like body containing a conductive substance such as copper on the vehicle interior side surface or the vehicle exterior side surface of the glass plate 110. Alternatively, the bus bars 130L and 130R and the plurality of heating wires 140 may be attached to the glass plate 110 with an adhesive or the like, or may be provided inside (inner layer) the glass plate 110 itself.

A camera 20 for acquiring an image of the outside of the vehicle can be mounted on the vehicle interior side of the vehicle window glass 100. FIG. 1 is a plan view illustrating a vehicle window glass 100 as seen from inside the vehicle, with the position of the camera 20 indicated by a dashed line. The position of the camera 20 is, more specifically, the position of the lens of the camera 20. An imaging range of the camera 20 is set in a wiring prohibited region 113 in plan view.

The camera 20 is mounted on the vehicle interior side with respect to the glass plate 110, and is a device (imaging unit) that images the outside of the vehicle (in the present embodiment, the rear side of the vehicle) through the glass plate 110. For example, by displaying an image captured by the camera 20 on a display in the vehicle interior, it is possible to assist a driver of the vehicle to visually recognize a situation around the vehicle.

Note that a lamp may be provided in the wiring prohibited region 113 instead of the camera 20. The lamp is, for example, a high mount stop lamp. When the lamp emits light, it is possible to notify the driver of the following vehicle that the brake operation of the own vehicle has been performed. The lamp is a device that is mounted on the vehicle interior side relative to the glass plate 110 and radiates light through the glass plate 110 toward the outside of the vehicle (toward the rear of the vehicle in the present embodiment).

### <Glass Plate 110>

The glass plate 110 is an example of a glass plate for a vehicle window. The outer shape of the glass plate 110 is substantially quadrangular. An upper edge 110U represents a glass edge on an upper side of the glass plate 110, and a bottom edge 110B represents a glass edge on a lower side (opposite to the upper edge 110U side) of the glass plate 110. A left edge 110L represents a glass edge on a left side of the glass plate 110, and a right edge 110R represents a glass edge on a right side (opposite to the left edge 110L side) of the glass plate 110. The left edge 110L is a glass edge adjacent to the left side of the upper edge 110U and the bottom edge 110B, and the right edge 110R is a glass edge adjacent to the right side of the upper edge 110U and the bottom edge 110B.

The glass plate 110 has a pair of side edges. The left edge 110L is an example of one first side edge of the pair of side edges, and the right edge 110R is an example of the other second side edge of the pair of side edges. The connecting portions of the upper edge 110U and the left edge 110L are connected with a curvature, but may be connected without a curvature. The shape of the connecting portion between the other edges is the same.

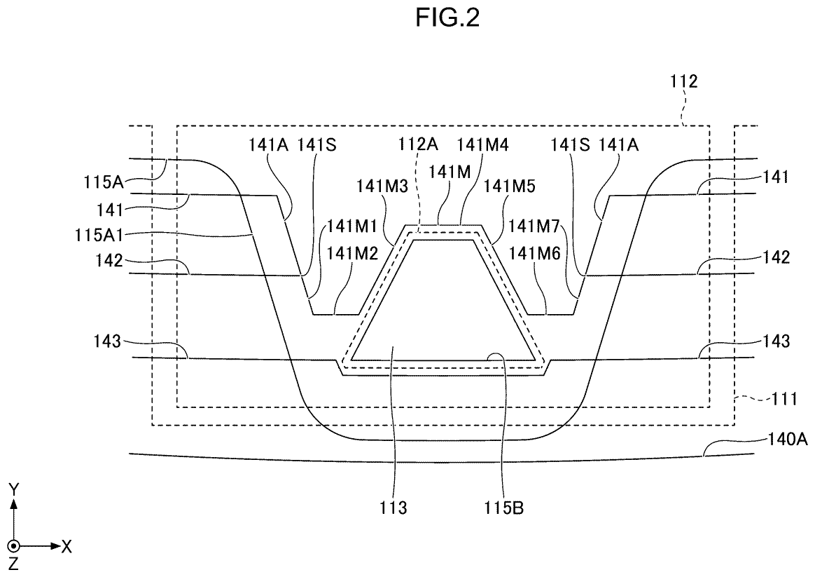

The glass plate 110 includes a first anti-fog region 111, a second anti-fog region 112, a wiring prohibited region 113, and a shielding film 115. Hereinafter, description will be given with reference to FIG. 2 in addition to FIG. 1. FIG. 2 is an enlarged view illustrating an example of a configuration of a portion around a wiring prohibited region 113 in an overall configuration of the vehicle window glass 100. In FIG. 2, the camera 20 is omitted.

### <First Anti-fog Region 111>

The first anti-fog region 111 is a region of the anti-fog region of the glass plate 110 excluding the second anti-fog region 112 located at the upper central portion and the wiring prohibited region 113 surrounded by the second anti-fog region 112. The anti-fog region of the glass plate 110 is a region that spreads inside a substantially rectangular region where the plurality of heating wires 140 are provided in the entire glass plate 110, and is an anti-fog region from which the fogging is removed by the heat generation of the plurality of heating wires 140.

The first anti-fog region 111 is a substantially U-shaped region including a portion of the anti-fog region of the glass plate 110 from the bottom edge 110B side to the lower end of the second anti-fog region 112, and portions on the left side and the right side of the second anti-fog region 112. The portion of the anti-fog region from the lower edge 110B side to the lower end of the second anti-fog region 112 is, as an example, a portion where the fourth to the fourteenth heating wires 140A from the top among the fourteen heating wires 140 extend in the lateral direction. The outer edge of the first anti-fog region 111 is located outside the portion other than a protrusion 115A1 in an opening 115A of the shielding film 115.

### <Second Anti-Fog Region 112>

The second anti-fog region 112 is a portion obtained by removing the wiring prohibited region 113 from the central portion in the lateral direction of the portion on the upper end side of the anti-fog region of the glass plate 110. The portion on the upper end side of the anti-fog region is, as an example, a portion in which a first heating wire 141, a second heating wire 142, and a third heating wire 143, which correspond to the first to third heating wires from the top among the fourteen heating wires 140 provided in the vertical direction of the glass plate 110, are arranged.

The second anti-fog region 112 surrounds the periphery of the wiring prohibited region 113. The second anti-fog region 112 is a substantially rectangular ring-shaped region that surrounds the periphery of the wiring prohibited region 113. FIG. 2 illustrates an inner edge 112A of the second anti-fog region 112. The inner edge 112A is an inner edge of the second anti-fog region 112 having a substantially rectangular annular shape. The region inside the inner edge 112A is a region not included in the second anti-fog region 112. The wiring prohibited region 113 is located inside the inner edge 112A of the second anti-fog region 112. The second anti-fog region 112 overlaps substantially the entire protrusion 115A1 of the shielding film 115. As an example, the lower end of the second anti-fog region is located between the third heating wire 143 and the heating wire 140A which corresponds to the fourth heating wire. In FIGS. 1 and 2, the lower end of the protrusion 115A1 of the shielding film 115 protrudes downward from the second anti-fog region 112, but the lower end of the protrusion 115A1 may be accommodated in the second anti-fog region 112.

### <Wiring Prohibited Region 113>

The wiring prohibited region 113 is a region surrounded by the second anti-fog region 112 at the central portion in the lateral direction on the upper edge 110U side of the glass plate 110. The wiring prohibited region 113 is a region where wiring such as a heating wire and an antenna is prohibited, and is, as an example, a trapezoidal region in which a lower base is longer than an upper base in plan view. The outer edge of the wiring prohibited region 113 has a trapezoidal shape. The wiring prohibited region 113 includes an imageable region defined by the angle of view of the camera 20 provided in the room toward the rear of the vehicle, and is a region wider than the imageable region defined by the angle of view. The image captured by the camera 20 can be displayed on a display or the like of the vehicle.

Since a composite heating wire 141M of the first heating wire 141 and the second heating wire 142 and the third heating wire 143 surround the wiring prohibited region 113 and are located outside the wiring prohibited region 113, the composite heating wire 141M and the third heating wire 143 can be prevented from being reflected in the image captured by the camera 20. In addition, when a voltage is applied between the pair of bus bars 130L and 130R, the composite heating wire 141M and the third heating wire 143 are energized to generate heat, so that heat is transferred from the second anti-fog region 112 outside the wiring prohibited region 113 to the wiring prohibited region 113, and it is possible to remove fogging in the wiring prohibited region 113.

Note that, here, as an example, an aspect will be described in which the wiring prohibited region 113 is located at a central portion in the lateral direction on the upper edge 110U side of the glass plate 110, but the wiring prohibited region 113 may be located at a portion other than the central portion in the lateral direction on the upper edge 110U side of the glass plate 110. As an example, the wiring prohibited region 113 may be located on the right side or the left side of the central portion in the lateral direction on the upper edge 110U side of the glass plate 110.

### <Shielding Film 115>

The shielding film 115 is a frame-like film provided along an outer edge (upper edge 110U, left edge 110L, bottom edge 110B, and right edge 110R) of the glass plate 110. The shielding film 115 has an opening 115A that exposes substantially the entire inside of the outer edge of the glass plate 110 and an opening 115B that exposes the wiring prohibited region 113. The opening 115A has the protrusion 115A1 protruding downward from the upper edge 110U side and a protrusion 115A2 protruding upward from the bottom edge 110B side to surround the wiring prohibited region 113 in the upper central portion of the glass plate 110. The protrusion 115A1 protrudes downward to surround the wiring prohibited region 113, and the protrusion 115A2 protrudes upward to avoid a drive shaft of a wiper (not illustrated). The opening 115B is provided in the protrusion 115A1, and is a trapezoidal opening in plan view that exposes the entire wiring prohibited region 113. The opening region of the opening 115B is equal to the wiring prohibited region 113.

Since the shielding film 115 avoids the wiring prohibited region 113, it is possible to prevent the shielding film 115 from being reflected in the image captured by the camera 20. Specific examples of the shielding film 115 include ceramics such as a black ceramic film. The shielding film 115 is formed by printing and baking a ceramic paste containing a black pigment and glass frit on the vehicle interior side surface of the glass plate 110. As a method for printing a paste containing a black pigment and glass frit, a screen printing method, an offset printing method, a gravure printing method, a flexographic printing method, an inkjet printing method, or the like can be used. When the glass plate 110 is viewed from the outside of the vehicle, a portion overlapping the shielding film 115 cannot be seen from the outside of the vehicle, and the glass plate 110 having an excellent design can be obtained.

### <Defogger 120>

The defogger 120 is an electric heating type conductor pattern that removes fogging of the glass plate 110. The defogger 120 includes a plurality of heating wires 140 extending in the lateral direction of the glass plate 110 and a plurality of bus bars 130L and 130R that supply power to the plurality of heating wires 140. In the present embodiment, fourteen heating wires 140 extending in the lateral direction of the glass plate 110 so as to run parallel to each other, and a pair of bus bars 130L and 130R connected to the 14 heating wires 140 are provided on the glass plate 110. When a voltage is applied between the pair of bus bars 130L and 130R, the fourteen heating wires 140 are energized to generate heat, so that the fogging of the glass plate 110 is removed.

### <Bus Bars 130L and 130R>

The bus bars 130L and 130R are conductor patterns extending in the vertical direction along the left edge 110L and the right edge 110R of the glass plate 110, respectively. The left bus bar 130L is an example of the first bus bar, and the right bus bar 130R is an example of the second bus bar. The fourteen heating wires 140 are connected between the bus bars 130L and 130R. The bus bars 130L and 130R are located outside the opening 115A of the shielding film 115 and overlap the shielding film 115.

The bus bar 130L is connected to one terminal (for example, a positive terminal) of a DC power supply (not illustrated) of the vehicle as an example, and the bus bar 130R is connected to the other terminal (for example, a negative terminal) of the DC power supply (not illustrated) of the vehicle as an example. The DC power is supplied from a DC power supply (not illustrated) of the vehicle to the bus bars 130L and 130R.

Although the bus bars 130L and 130R illustrated in FIG. 1 are clearly wider than the heating wire 140, the bus bars 130L and 130R may have a width substantially equal to the width of the heating wire 140. However, since the bus bars 130L and 130R are located at the left and right ends of the first anti-fog region 111, the bus bars are portions that do not contribute to heating of the first anti-fog region 111 regardless of the width. In addition, in FIG. 1, the bus bars 130L and 130R are located inside the first anti-fog region 111, but the bus bars 130L and 130R may be located outside the first anti-fog region 111.

### <Heating Wire 140>

The fourteen heating wires 140 are conductor patterns connected between the bus bars 130L and 130R. Here, as an example, it is assumed that a current flows from the left bus bar 130L to the right bus bar 130R. In addition, the width of the heating wire 140 means a wire width.

Each of the fourteen heating wires 140 has a left end portion connected to the left bus bar 130L and a right end portion connected to the right bus bar 130R. The left end portion of each heating wire 140 is a connecting portion between the left bus bar 130L and each heating wire 140, and the right end portion of each heating wire 140 is a connecting portion between the right bus bar 130R and each heating wire 140. The left end portion and the right end portion of each of the fourteen heating wires 140 overlap the shielding film 115.

Among the fourteen heating wires 140, the three heating wires 140 on the upper side are the first heating wire 141, the second heating wire 142, and the third heating wire 143. The first heating wire 141 is the first heating wire located at the uppermost position from the top, the second heating wire 142 is the second heating wire from the top, and the third heating wire 143 is the third heating wire from the top. In the case where the three heating wires 140 on the upper side among the fourteen heating wires 140 are particularly distinguished, they are referred to as the first heating wire 141, the second heating wire 142, and the third heating wire 143. Also, in the case where the heating wires 140 from the fourth to the fourteenth from the upper side, excluding the three heating wires 140 on the upper side (the first heating wire 141, the second heating wire 142, and the third heating wire 143), among the fourteen heating wires 140 are distinguished, they are referred to as heating wires 140A. In addition, the fourteen heating wires 140 are simply referred to as the heating wire 140 unless otherwise distinguished.

Here, as an example, an aspect in which the fourteen heating wires 140 have bilaterally symmetrical shapes with a straight line passing through the center in the lateral direction of the glass plate 110 in the vertical direction as a symmetry axis will be described. However, the fourteen heating wires 140 may not have a bilaterally symmetrical shape with respect to the above-described symmetry axis. As an example, in a case where the wiring prohibited region 113 is located in a portion other than the central portion in the lateral direction on the upper edge 110U side of the glass plate 110, the shapes of the fourteen heating wires 140 are left-right asymmetric.

### <Fourth to Fourteenth Heating Wires 140A>

The fourth to fourteenth heating wires 140A are connected between the bus bars 130L and 130R in a region below the second anti-fog region 112 in the first anti-fog region 111, and extend in the lateral direction. The fourth to fourteenth heating wires 140A do not overlap the shielding film 115 except for the left end portion and the right end portion, and are located inside the opening 115A.

In order to uniformly heat the glass plate 110, an interval between the fourth to fourteenth heating wires 140A in the vertical direction is a substantially constant value. In addition, the fourth to fourteenth heating wires 140A have substantially the same length between the bus bars 130L and 130R, and have the same resistance value. Therefore, the speed at which the fogging is removed can be equalized, and unevenness in removal of the fogging can be prevented.

In FIG. 1, the thirteenth heating wire 140A and the fourteenth heating wire 140A are connected to each other at the central portion in the lateral direction to form a single composite heating wire 140A1 in order to avoid the protrusion 115A2. When the fourteenth heating wire 140A is curved on the upper side to avoid the protrusion 115A2, the distance from the thirteenth heating wire 140A is narrowed, and the temperature distribution becomes uneven. Therefore, by providing the composite heating wire 140A1, an even temperature distribution can be obtained.

<First Heating Wire 141, Second Heating Wire 142, and Third Heating Wire 143, which are First to Third Heating Wires>

The first heating wire 141, the second heating wire 142, and the third heating wire 143 are connected between the bus bars 130L and 130R on the left side and the right side of the protrusion 115A1 of the shielding film 115, similarly to the fourth to fourteenth heating wires 140A, and are extend in the lateral direction. Also, the first heating wire 141, the second heating wire 142, and the third heating wire 143 are wired, on the left and right sides of the protrusion 115A1 located above the shielding film 115, at intervals approximately equal to the intervals in the vertical direction of the fourth to fourteenth heating wires 140A. Here, an aspect in which the first to third heating wires from the top among the fourteen heating wires 140A are the first heating wire 141, the second heating wire 142, and the third heating wire 143 will be described, but one or more heating wires 140 may be further provided above the first heating wire 141.

### <First Heating Wire 141 and Second Heating Wire 142>

The first heating wire 141 and the second heating wire 142 are connected to each other to form a single composite heating wire 141M in the connecting portion 141S provided one by one on the left side and the right side of the wiring prohibited region 113 (opening 115B) inside the protrusion 115A1. That is, the first heating wire 141 and the second heating wire 142 are integrated into a single composite heating wire 141M between the two connecting portions 141S.

The first heating wire 141 has the heating wire portion 141A that is bent toward the second heating wire 142 and extends obliquely downward at the center of the glass plate 110 in the lateral direction. The lower end of the heating wire portion 141A is connected to the second heating wire 142 at a connecting portion 141S. The heating wire portion 141A and the connecting portion 141S are located in the second anti-fog region 112 and overlap the shielding film 115. In addition, a part of the first heating wire 141 on the side closer to the heating wire portion 141A and a part of the second heating wire 142 on the side closer to the connecting portion 141S are located in the second anti-fog region 112 and overlap the shielding film 115 in the portion extending in the lateral direction.

Here, an aspect in which the first heating wire 141 and second heating wire 142 are connected at the connecting portion 141S to form a single composite heating wire 141M will be described. However, in addition to the first heating wire 141 and the second heating wire 142, another heating wire may be connected at the connecting portion 141S to form the single composite heating wire 141M. That is, three or more heating wires 140 may be connected at the connecting portion 141S to form the single composite heating wire 141M.

In addition, a configuration in which the connecting portions 141S of the first heating wires 141 and the second heating wires 142 are provided on the left side and the right side of the wiring prohibited region 113 will be described here, but the connecting portions 141S may be provided on either the left side or the right side of the wiring prohibited region 113. In this case, for example, only one of the first heating wires 141 and the second heating wires 142 is present on the left side and the right side of the wiring prohibited region 113 where the connecting portion 141S is not present. As an example, in a case where the wiring prohibited region 113 is located in a portion other than the central portion in the lateral direction on the upper edge 110U side of the glass plate 110 and the shapes of the fourteen heating wires 140 are left-right asymmetric, the connecting portion 141S can be provided on either one of the left side and the right side of the wiring prohibited region 113.

### <Composite Heating Wire 141M>

The composite heating wire 141M is a part of the first heating wire 141 and the second heating wire 142. As illustrated in FIG. 2, the composite heating wire 141M includes composite heating wire portions 141M1, 141M2, 141M3, 141M4, 141M5, 141M6, and 141M7. The composite heating wire 141M has a configuration in which the composite heating wire portions 141M1 to 141M7 are connected between the two left and right connecting portions 141S. The composite heating wire 141M overlaps the shielding film 115.

The composite heating wire portion 141M1 extends obliquely downward to the right from the connecting portion 141S on the left side and is connected to the composite heating wire portion 141M2. The composite heating wire portion 141M2 extends rightward from a connecting portion with the composite heating wire portion 141M1 to a position in front of the wiring prohibited region 113 and is connected to the composite heating wire portion 141M3. The composite heating wire portion 141M3 extends obliquely upward to the right from the connecting portion with the composite heating wire portion 141M2 along the left edge of the wiring prohibited region 113 and is connected to the composite heating wire portion 141M4.

The composite heating wire portion 141M4 extends rightward from the connecting portion with the composite heating wire portion 141M3 along the upper edge of the wiring prohibited region 113 and is connected to the composite heating wire portion 141M5. The composite heating wire portion 141M5 extends obliquely downward to the right from the connecting portion with the composite heating wire portion 141M4 along the right edge of the wiring prohibited region 113, and is connected to the composite heating wire portion 141M6. The composite heating wire portion 141M6 extends rightward from the connecting portion with the composite heating wire portion 141M5 and is connected to the composite heating wire portion 141M7. The composite heating wire portion 141M7 extends obliquely upward to the right from a connecting portion with the composite heating wire portion 141M6 to the connecting portion 141S on the right side.

The composite heating wire portion 141M1 extends obliquely downward to the right from the connecting portion 141S on the left side in order to increase the area of the outer edge of the trapezoid of the wiring prohibited region 113 that is surrounded by the composite heating wire 141M and the third heating wire 143. This is for equalizing the temperature distribution of the glass plate 110 in the wiring prohibited region 113. In addition, when viewed from the side of the bus bar 130L, the composite heating wire portion 141M1 is a heating wire in which the first heating wire 141 and the second heating wire 142 merge at the connecting portion 141S on the left side to form a single wire, and thus, a current combining the currents flowing through the first heating wire 141 and the second heating wire 142 flows. In order to make the heat generation amounts of the first heating wire 141 and the second heating wire 142 on the left side of the connecting portion 141S on the left side and the composite heating wire portion 141M1 substantially equal, the width of the composite heating wire portion 141M1 is made larger than the widths of the first heating wire 141 and the second heating wire 142. As an example, since a current twice as large as the current flowing through each of the first heating wire 141 and the second heating wire 142 flows through the composite heating wire portion 141M1, the width of the composite heating wire portion 141M1 is made larger than the widths of the first heating wire 141 and the second heating wire 142. Note that, due to the left-right symmetry of the composite heating wire portions 141M1 to 141M7, the configuration of the composite heating wire portion 141M1 has a left-right inverted configuration of the composite heating wire portion 141M7.

Since the vertical interval between the composite heating wire portion 141M2 and the third heating wire 143 directly below it is narrower than the vertical intervals between the fourth to fourteenth heating wires 140A, as well as the vertical intervals between the first to third heating wires 141 to 143, the width of the composite heating wire portion 141M2 is made thicker than the widths of the heating wires 140A and the first to third heating wires 141 to 143. This is because, by increasing the width of the composite heating wire portion 141M2 to reduce the resistance value, the amount of heat generation in the composite heating wire portion 141M2 is reduced to be smaller than the amount of heat generation of the third heating wire 143, and the temperature distribution of the portion where the composite heating wire portion 141M2 and the third heating wire 143 exist is aligned with the surrounding temperature distribution. Note that, due to the left-right symmetry of the composite heating wire portions 141M1 to 141M7, the configuration of the composite heating wire portion 141M2 has a left-right inverted configuration of the composite heating wire portion 141M6.

The composite heating wire portions 141M3 to 141M5 extend to the upper side of the wiring prohibited region 113 along the section on the upper side, the section on the left side, and the section on the right side (sections on three sides other than the lower base of the trapezoid) among the upper, lower, left, and right sections of the trapezoidal wiring prohibited region 113 in plan view. The composite heating wire portion 141M4 is a section of the composite heating wire 141M extending in the lateral direction on the upper side of the wiring prohibited region 113. In addition, there is no heating wire above the composite heating wire portions 141M3 to 141M5. Therefore, the composite heating wire portions 141M3 to 141M5 play a role of uniformly heating the substantially upper half of the wiring prohibited region 113. The widths of the composite heating wire portions 141M3 to 141M5 are narrower than the width of the composite heating wire portion 141M2, and is configured to generate a larger amount of heat than the composite heating wire portion 141M2.

As an example, the widths of the composite heating wire portions 141M3 to 141M5 are constant from the connecting portion of the composite heating wire portion 141M3 with the composite heating wire portion 141M2 to the connecting portion of the composite heating wire portion 141M5 with the composite heating wire portion 141M6. This is because the substantially upper half region of the wiring prohibited region 113 is uniformly heated with a uniform amount of heat generation. Since the current flowing through the composite heating wire portion 141M2 flows in the composite heating wire portions 141M3 to 141M5 as it is, the widths of the composite heating wire portions 141M3 to 141M5 are larger than the widths of the first heating wire 141 and the second heating wire 142.

The composite heating wire portion 141M6 has a configuration in which the composite heating wire portion 141M2 is horizontally inverted. Since the vertical interval between the composite heating wire portion 141M6 and the third heating wire 143, which are located directly below, it is narrower than the vertical intervals between the fourth to fourteenth heating wires 140A, as well as the vertical intervals between the first to third heating wires 141 to 143, the width of the composite heating wire portion 141M6 is made thicker than the widths of the heating wires 140A and the first to third heating wires 141 to 143.

The composite heating wire portion 141M7 has a configuration in which the composite heating wire portion 141M1 is horizontally inverted. The composite heating wire portion 141M7 is disposed at the same position as the composite heating wire portion 141M1 in the vertical direction in order to increase a portion surrounding the outer edge of the trapezoid of the wiring prohibited region 113 with the composite heating wire 141M and the third heating wire 143 and to make the temperature distribution in the wiring prohibited region 113 symmetrical in the lateral direction. The length of the composite heating wire portion 141M7 in the lateral direction is equal to the length of the composite heating wire portion 141M1 in the lateral direction.

As described above, the composite heating wire portions 141M3 and 141M5 overlap the shielding film 115. Since the fourteen heating wires 140 extend in the lateral direction corresponding to the horizontal direction in most regions, the heating wires having an angle with respect to the lateral direction are easily noticeable. In addition, the heating wire extending in the lateral direction corresponding to the horizontal direction overlaps the horizontal portion of the landscape viewed through the glass plate 110, and thus, is hardly visible to a human, but the heating wire having an angle with respect to the lateral direction tends to be easily visible and easily stand out.

The composite heating wire portions 141M3 and 141M5 have an angle with respect to the lateral direction, but are not conspicuous because they are located outside the opening 115B surrounding the wiring prohibited region 113 and overlap the shielding film 115. Therefore, good design can be obtained without impairing the appearance of the glass plate 110. The composite heating wire portions 141M3 and 141M5 may not overlap the shielding film 115. In this case, the heating wire portion 141A of the first heating wire 141 may not overlap the shielding film 115.

### <Third Heating Wire 143>

The third heating wire 143 extends in the lateral direction below the wiring prohibited region 113. The third heating wire 143 is bent downward in a crank shape as compared with the sections on the left side and the right side of the wiring prohibited region 113 in order to avoid the wiring prohibited region 113 immediately below the wiring prohibited region 113. However, in a case where the lower end of the wiring prohibited region 113 is located above as compared with the configuration illustrated in FIGS. 1 and 2, or in a case where the interval between the plurality of heating wires 140 is wide, or the like, the third heating wire 143 may extend linearly without being bent between the bus bars 130L and 130R, similarly to the fourth to fourteenth heating wires 140.

The first heating wire 141 and the second heating wire 142 are integrated between the two connecting portions 141S on both sides of the wiring prohibited region 113 to form a single composite heating wire 141M, the composite heating wire 141M extends along the sections on the left side, the upper side, and the right side of the outer edge of the wiring prohibited region 113, and the third heating wire 143 extends along the section on the lower side of the outer edge of the wiring prohibited region 113. Further, the intervals in the vertical direction between the composite heating wire portions 141M2 and 141M6 of the composite heating wire 141M and the third heating wire 143 are narrowed, and the composite heating wire portions 141M2 and 141M6 approach the third heating wire 143. Since the composite heating wire 141M and the third heating wire 143 surround substantially the entire circumference around the wiring prohibited region 113, the temperature of the wiring prohibited region 113 of the glass plate 110 can be raised to a desired temperature, and the temperature distribution can be made more uniform. Therefore, the fogging in the wiring prohibited region 113 can be removed without unevenness.

In addition, the composite heating wire portions 141M2 and 141M6 are made thicker than the third heating wire 143 to reduce the amount of heat generation, so that the temperature distribution between the third heating wire 143 and the composite heating wire portions 141M2 and 141M6 is equalized with the other portions. Therefore, the temperature of the wiring prohibited region 113 of the glass plate 110 can be increased to a desired temperature, and the temperature distribution can be made more uniform, so that the fogging in the wiring prohibited region 113 can be removed evenly and reliably.

### <Simulation Result of Temperature Distribution>

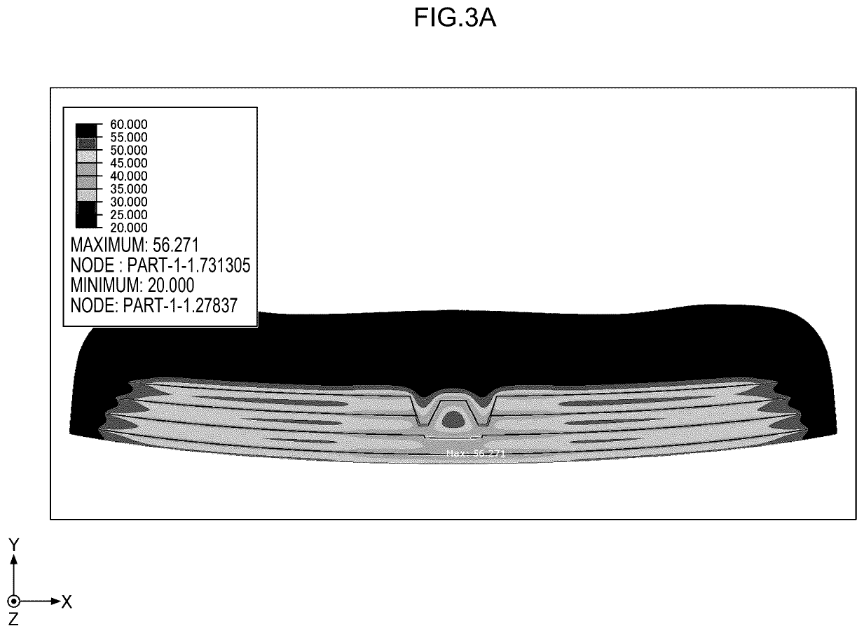

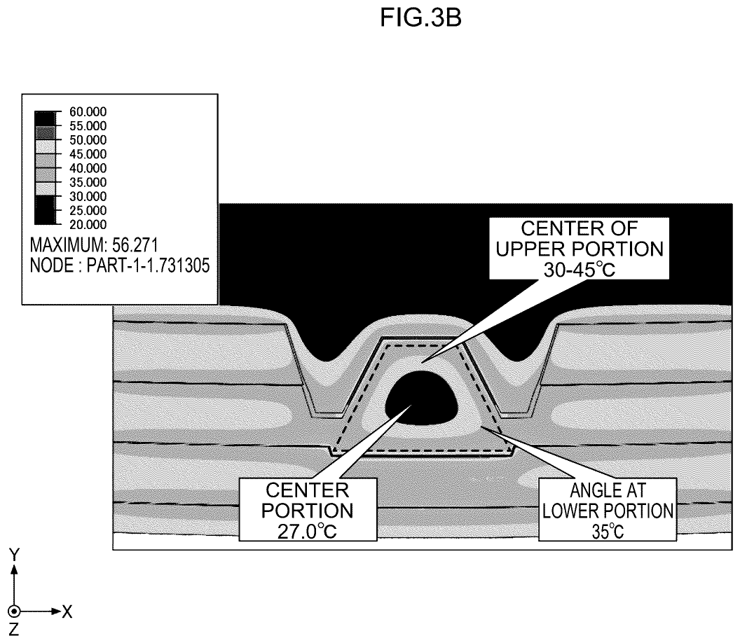

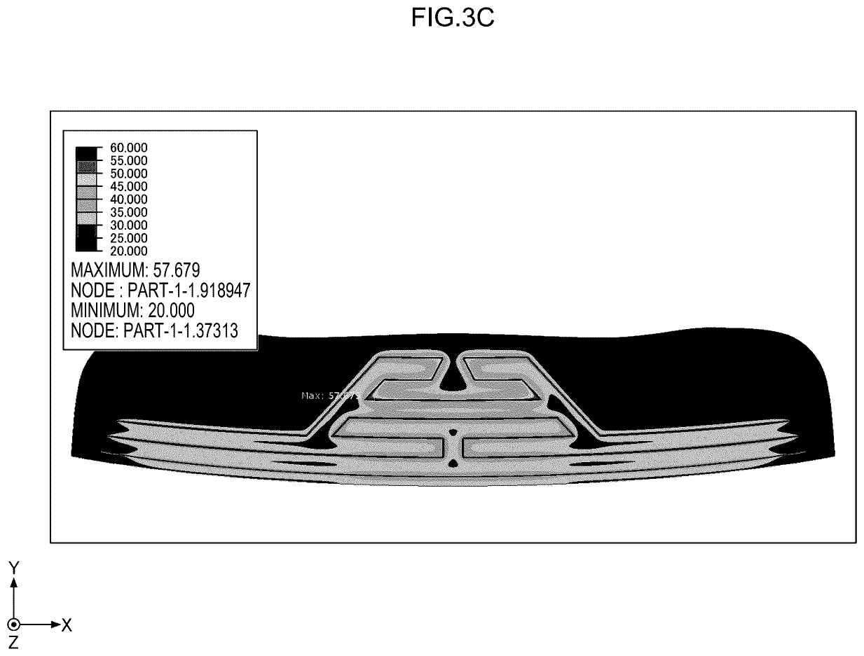

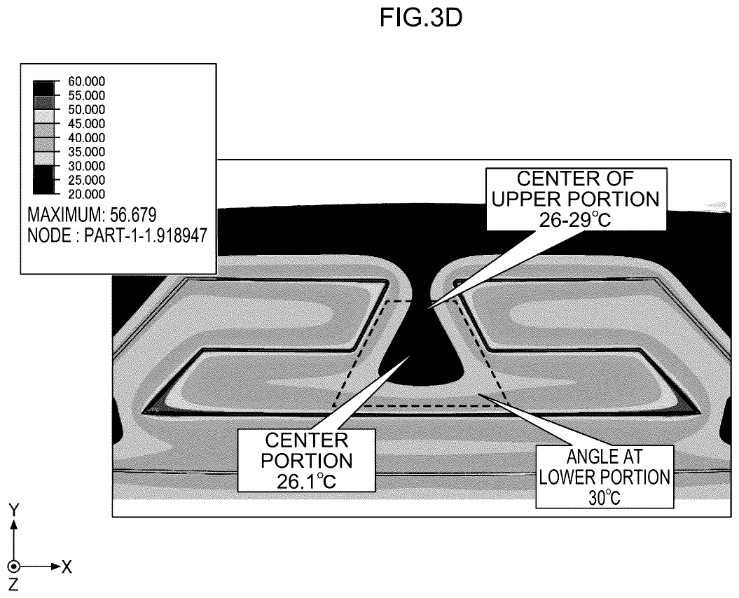

FIGS. 3A and 3B are diagrams illustrating an example of a simulation result of a temperature distribution in the vehicle window glass 100 according to the embodiment. FIG. 3 A illustrates a temperature distribution in a portion from the first heating wire 141 to the fourth heating wire 140A of the glass plate 110, and FIG. 3B illustrates an enlarged temperature distribution in wiring prohibited region 113 and its surroundings. In FIG. 3B, the wiring prohibited region 113 is indicated by a broken trapezoid.

As an example, FIG. 3A and FIG. 3B illustrate the temperature distribution 30 minutes after the current of the predetermined electric power flows between the bus bars 130L and 130R. In addition, FIG. 3B illustrates a state in which the widths of the composite heating wire portions 141M1 to 141M7 of the composite heating wire 141M is set as described above.

As illustrated in FIG. 3A, a temperature distribution of about 25° C. or higher was obtained as a whole in a portion from the first heating wire 141 to the fourth heating wire 140A of the glass plate 110. As illustrated in FIG. 3A, the maximum temperature was 56.271° C. at the center portion of the third heating wire 143 in the lateral direction. In addition, as illustrated in FIG. 3B, the temperature was 27.0° C. at the center portion of the wiring prohibited region 113, 30° C. to 45° C. at the center of the upper portion of the wiring prohibited region 113, and 35° C. at the corner of the lower portion of the wiring prohibited region 113, and a good temperature distribution was obtained in the wiring prohibited region 113. The good temperature distribution means a uniform temperature distribution with a small difference in temperature.

The widths of the composite heating wire portions 141M3 to 141M5 are narrower than the width of the composite heating wire portion 141M2, and is configured to generate a larger amount of heat than the composite heating wire portion 141M2. In addition, the widths of the composite heating wire portions 141M3 to 141M5 are constant from the connecting portion of the composite heating wire portion 141M3 with the composite heating wire portion 141M2 to the connecting portion of the composite heating wire portion 141M5 with the composite heating wire portion 141M6. Therefore, as illustrated in FIG. 3B, a good temperature distribution is obtained within the wiring prohibited region 113. It has been confirmed that, when the widths of the composite heating wire portions 141M3 to 141M5 are not made constant between the composite heating wire portions 141M2 and 141M6 as described above, the uniformity of the temperature distribution in the wiring prohibited region 113 decreases.

### <Simulation Result of Temperature Distribution in Comparative Vehicle Window Glass>

FIGS. 3C and 3D are diagrams illustrating an example of a simulation result of temperature distribution in a comparative vehicle window glass. The comparative vehicle window glass is the vehicle window glass of WO 2019/017246 A described as Patent Document 1. FIG. 3C illustrates the temperature distribution in a portion where three heating wires were installed from the upper side of the glass plate of a comparative vehicle window glass, and FIG. 3C illustrates an enlarged view of the temperature distribution in the wiring prohibited region and its surroundings. In FIG. 3D, a wiring prohibited region of the comparative vehicle window glass is indicated by a broken trapezoid.

As an example, FIG. 3C and FIG. 3D illustrate temperature distributions 30 minutes after a current of the same electric power as the current flowing in the simulation of the vehicle window glass 100 according to the embodiment is caused to flow between the left and right bus bars.

As illustrated in FIG. 3C, a temperature distribution of about 25° C. or higher is obtained as a whole in the portion of the first to third heating wires from the upper side, but it has been found that the temperature on the upper side of the wiring prohibited region is lower than that of the vehicle window glass 100 of the embodiment. As illustrated in FIG. 3C, the maximum temperature was 57.679° C. in the portion where the first heating wire was bent on the left and right of the wiring prohibited region. In addition, as illustrated in FIG. 3D, the temperature was 26.1° C. at the center portion of the wiring prohibited region, 26° C. to 29° C. at the center of the upper portion of the wiring prohibited region, and 30° C. at the corner of the lower portion of the wiring prohibited region. As compared with the wiring prohibited region 113 of the vehicle window glass 100 of the embodiment, the temperature was generally low and the temperature difference was large.

As described above, in the vehicle window glass 100 according to the embodiment, by providing the composite heating wire 141M in which the first heating wire 141 and the second heating wire 142 are combined into a single wire along the left side, the upper side, and the right side of the wiring prohibited region 113, and by providing the third heating wire 143 along the lower side of the wiring prohibited region 113, it has been confirmed that the overall temperature rise in the wiring prohibited region 113 and the improvement of the uniformity of the temperature distribution can be realized as compared with the comparative vehicle window glass. By realizing the increase in the overall temperature in the wiring prohibited region 113 and the improvement in the uniformity of the temperature distribution, the speed at which the fogging in the wiring prohibited region 113 is removed can be equalized in the wiring prohibited region 113, and the removal of the fogging can be made less uneven.

### First Modification Example

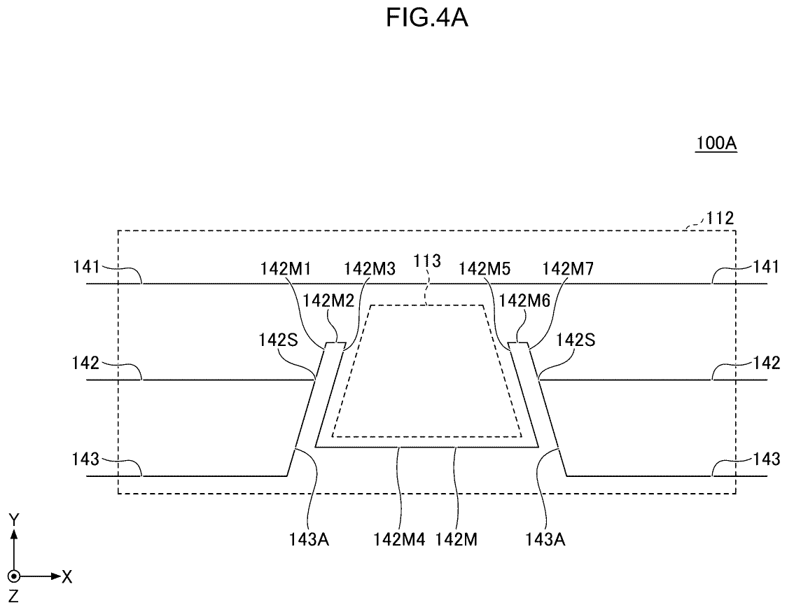

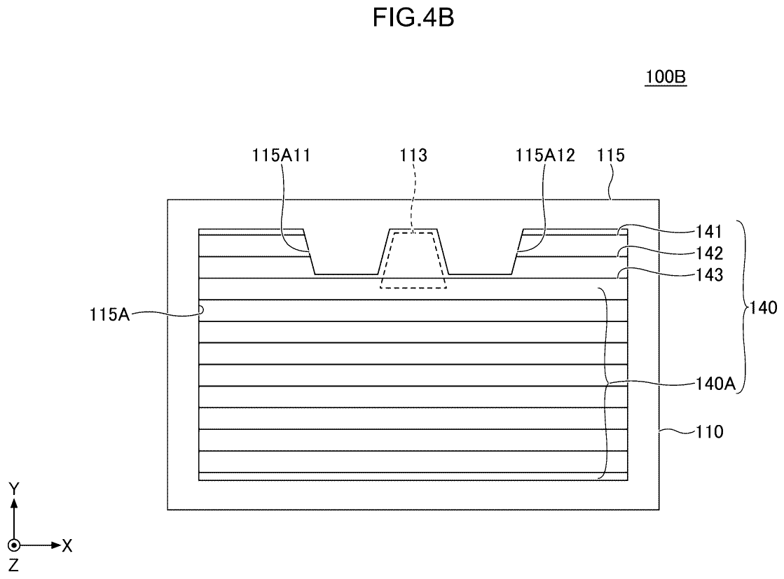

FIG. 4A is a diagram illustrating examples of configurations of the first heating wire 141, the second heating wire 142, and the third heating wire 143 in the second anti-fog region 112 of a vehicle window glass 100A according to a first modification example of the embodiment.

In the first modification example illustrated in FIG. 4A, the first heating wire 141 extends to the left and right on the upper side of the wiring prohibited region 113, and the second heating wire 142 and the third heating wire 143 are connected by two connecting portions 142S located on the left and right of the wiring prohibited region 113 to form a single composite heating wire 142M. The first heating wire 141 is not connected to other heating wires.

The third heating wire 143 has the heating wire portion 143A that is bent toward the second heating wire 142 and extends obliquely upward at the center of the glass plate 110 in the lateral direction. The upper end of the heating wire portion 143A is connected to the second heating wire 142 at the connecting portion 142S. The heating wire portion 143A and the connecting portion 142S are located within the second anti-fog region 112, and overlap the shielding film 115 (not illustrated in FIG. 4A). In addition, the portions of the second heating wire 142 and the third heating wire 143 extending in the lateral direction illustrated in FIG. 4A are located in the second anti-fog region 112 and overlap the shielding film 115 (not illustrated in FIG. 4A).

### <Composite Heating Wire 142M>

The composite heating wire 142M is a part of the second heating wire 142 and the third heating wire 143. As illustrated in FIG. 4A, the composite heating wire 142M includes composite heating wire portions 142M1, 142M2, 142M3, 142M4, 142M5, 142M6, and 142M7. The composite heating wire 142M has a configuration in which the composite heating wire portions 142M1 to 142M7 are connected between the two left and right connecting portions 142S. The composite heating wire 142M overlaps with the shielding film 115 (not shown in FIG. 4A).

The composite heating wire portion 142M1 extends obliquely downward to the right from the connecting portion 142S on the left side and is connected to the composite heating wire portion 142M2. The composite heating wire portion 142M2 extends rightward from a connecting portion with the composite heating wire portion 142M1 to a position in front of the wiring prohibited region 113 and is connected to the composite heating wire portion 142M3. The composite heating wire portion 142M3 extends obliquely downward to the left from the connecting portion with the composite heating wire portion 142M2 along the left edge of the wiring prohibited region 113 and is connected to the composite heating wire portion 142M4. The composite heating wire portion 142M4 extends rightward from the connecting portion with the composite heating wire portion 142M3 along the bottom edge of the wiring prohibited region 113 and is connected to the composite heating wire portion 142M5. The composite heating wire portion 142M5 extends obliquely upward to the left from the connecting portion with the composite heating wire portion 142M4 along the right edge of the wiring prohibited region 113, and is connected to the composite heating wire portion 142M6. The composite heating wire portion 142M6 extends rightward from the connecting portion with the composite heating wire portion 142M5 and is connected to the composite heating wire portion 142M7. The composite heating wire portion 142M7 extends obliquely downward to the right from a connecting portion with the composite heating wire portion 142M6 to the connecting portion 142S on the right side.

Note that, due to the left-right symmetry of the composite heating wire portions 142M1 to 142M7, the configuration of the composite heating wire portion 142M1 has a left-right inverted configuration of the composite heating wire portion 142M7. The widths of the composite heating wire portions 142M1 to 142M7 may be set similarly to the widths of the composite heating wire portions 141M1 to 141M7 illustrated in FIG. 2. In particular, the widths of the composite heating wire portions 142M3 to 142M5 may be made constant between the composite heating wire portions 142M2 and 142M6 in order to equalize the temperature distribution in the wiring prohibited region 113.

As in the vehicle window glass 100A of the first modification example illustrated in FIG. 4A, a configuration including the composite heating wire 142M in which the second heating wire 142 and the third heating wire 143 are bundled into one may be adopted.

### Second Modification Example

FIG. 4B is a diagram illustrating an example of a configuration of a vehicle window glass 100B of a second modification example of the embodiment. In FIG. 4B, the whole is simplified, and a plurality of heating wires 140 are illustrated in a simplified manner. In the vehicle window glass 100B of the second modification example, the configuration of the shielding film 115 is different from the configuration of the shielding film 115 of the vehicle window glass 100 illustrated in FIGS. 1 and 2. In FIG. 4B, components other than the glass plate 110, the wiring prohibited region 113, the shielding film 115, and the simplified plurality of heating wires 140 are omitted.

In the shielding film 115 of the second modification example, the opening 115A has two protrusions 115A11 and 115A12. The two protrusions 115A11 and 115A12 have a configuration in which a portion of the protrusion 115A1 illustrated in FIG. 2 located below the wiring prohibited region 113 is omitted. Therefore, the section on the lower side of the outer edge of the wiring prohibited region 113 is not surrounded by the shielding film 115. In addition, the third heating wire 143 extends to the left and right below two protrusions 115A11 and 115A12, and does not have a section overlapping the shielding film 115.

As in the vehicle window glass 100B of the second modification example illustrated in FIG. 4B, the section on the lower side of the outer edge of the wiring prohibited region 113 may not be surrounded by the shielding film 115, and the third heating wire 143 may not have a section overlapping the shielding film 115.

### <Effects>

The vehicle window glass 100 includes the vehicle window glass that is the glass plate 110 having the wiring prohibited region 113, and the defogger 120 provided on the glass plate 110, the defogger 120 has a pair of bus bars 130L and 130R extending in the vertical direction of the glass plate 110, and a plurality of heating wires 140 connected between the pair of bus bars 130L and 130R and extending in the lateral direction of the glass plate 110, the glass plate 110 has the first anti-fog region 111 extending in the lateral direction between the pair of bus bars 130L and 130R, and the second anti-fog region 112 formed to surround the wiring prohibited region 113, the plurality of heating wires 140 include the first heating wire 141, the second heating wire 142, and the third heating wire 143 that pass through the second anti-fog region 112, the first heating wire 141 and the second heating wire 142 are connected to each other at the connecting portion 141S located around the wiring prohibited region 113 to form the single composite heating wire 141M, the composite heating wire 141M has a section extending in the lateral direction above the wiring prohibited region 113, the third heating wire 143 has a section extending in the lateral direction below the wiring prohibited region 113 or the first heating wire 141 has a section extending in the lateral direction above the wiring prohibited region 113, the second heating wire 142 and the third heating wire 143 are connected to each other at the connecting portion 142S located around the wiring prohibited region 113 to form the single composite heating wire 142M, and the composite heating wire 142M has a section extending in the lateral direction below the wiring prohibited region 113. Therefore, the wiring prohibited region 113 can be heated by the composite heating wire 141M from above and can be heated by the third heating wire 143 from below. Alternatively, the wiring prohibited region 113 can be heated by the first heating wire 141 from above and can be heated by the composite heating wire 142M from below.

Therefore, it is possible to provide the vehicle window glass 100 having a good temperature distribution in the wiring prohibited region 113.

In addition, the glass plate 110 may have the shielding film 115 formed along the outer edge of the glass plate 110 in plan view, the shielding film 115 may surround the outer edge of the wiring prohibited region 113, and a section extending in the lateral direction below wiring prohibited region 113 of the third heating wire 143 or a section extending in the lateral direction below the wiring prohibited region 113 of the composite heating wire 142M may overlap the shielding film 115. For this reason, a section extending in the lateral direction below the wiring prohibited region 113 of the third heating wire 143 or a section extending in the lateral direction below the wiring prohibited region 113 of the composite heating wire 142M is not visible from the outside of the vehicle. Therefore, it is possible to provide the vehicle window glass 100 that is excellent in design and has a good temperature distribution in the wiring prohibited region 113.

In addition, the glass plate 110 has, in a plan view, the shielding film 115 formed along the outer edge of the glass plate 110, and the shielding film 115 surrounds the section on the upper side, the section on the left side, and the section on the right side among the upper, lower, left, and right sections of the outer edge of the wiring prohibited region 113, and is not provided in the section on the lower side of the outer edge of the wiring prohibited region 113, and the section extending in the lateral direction below the wiring prohibited region 113 of the third heating wire 143, or the section extending in the lateral direction below the wiring prohibited region 113 of the composite heating wire 142M, may be exposed from the shielding film 115. Therefore, the section extending in the lateral direction below the wiring prohibited region 113 of the third heating wire 143, or the section extending in the lateral direction below the wiring prohibited region 113 of the composite heating wire 142M, is visible from outside the vehicle, but the portion of the glass plate 110 covered by the shielding film 115 can be reduced. Therefore, it is possible to provide the vehicle window glass 100 having a good temperature distribution in the wiring prohibited region 113 while reducing the portion where the shielding film 115 covers the glass plate 110.

In addition, the composite heating wire 141M of the first heating wire 141 and the second heating wire 142 may be thicker than the portion other than the composite heating wire 141M of the first heating wire 141 and the second heating wire 142, or the composite heating wire 142M of the second heating wire 142 and the third heating wire 143 may be thicker than the portion other than the composite heating wire 142M of the second heating wire 142 and the third heating wire 143. Since the current flowing through both the first heating wire 141 and the second heating wire 142 flows through the composite heating wire 141M, by making the width of the composite heating wire 141M larger than the width of the portion other than the composite heating wire 141M of the first heating wire 141 and the second heating wire 142, the amount of heat generation in the composite heating wire 141M can be reduced, and the temperature distribution can be made more uniform. In addition, since the current flowing through both the second heating wire 142 and the third heating wire 143 flows through the composite heating wire 142M, by making the width of the composite heating wire 142M larger than the width of the portion other than the composite heating wire 142M of the second heating wire 142 and the third heating wire 143, the amount of heat generation in the composite heating wire 142M can be made equal to the amount of heat generation in the portions other than the composite heating wire 142M of the second heating wire 142 and the third heating wire 143, and the temperature distribution in the wiring prohibited region 113 can be made more uniform.

In addition, the composite heating wire 141M of the first heating wire 141 and the second heating wire 142 may be provided along the section on the upper side, the section on the left side, and the section on the right side among the upper, lower, left, and right sections of the outer edge of the wiring prohibited region 113, and the portion where the composite heating wire 141M is provided along the section on the upper side, the section on the left side, and the section on the right side may be thicker than the portion other than the composite heating wire 141M of the first heating wire 141 and the second heating wire 142. In addition, since the current flowing through both the first heating wire 141 and the second heating wire 142 flows through the composite heating wire 141M, by making the width of the composite heating wire 141M thicker than the width of the portions of the first heating wire 141 and the second heating wire 142 other than the composite heating wire 141M, the amount of heat generated in the composite heating wire 141M can be made equal to the amount of heat generated in the parts of the first heating wire 141 and the second heating wire 142 other than the composite heating wire 141M. By providing such a composite heating wire 141M along the section on the upper side, the section on the left side, and the section on the right side among the upper, lower, left, and right sections of the outer edge of the wiring prohibited region 113, the temperature in the wiring prohibited region 113 can be raised to a desired temperature, and the temperature distribution in the wiring prohibited region 113 can be made more uniform.

In addition, the first heating wire 141 and the second heating wire 142 extend in the lateral direction on a left side of the wiring prohibited region 113 and extend in the lateral direction on a right side of the wiring prohibited region 113, the connecting portion 141S is the connecting portion 141S located on a left side of the wiring prohibited region 113 and the connecting portion 141S located on a right side of the wiring prohibited region 113, and the composite heating wire 141M of the first heating wire 141 and the second heating wire 142 connects the connecting portion 141S located on a left side of the wiring prohibited region 113 and the connecting portion 141S located on a right side of the wiring prohibited region 113, and has a section extending in the lateral direction on an upper side of the wiring prohibited region 113. In a configuration in which the composite heating wire 141M extends between the left and right first heating wire 141 and second heating wire 142, the wiring prohibited region 113 can be heated from above by the composite heating wire 141M and can also be heated from below by the third heating wire 143. Therefore, in the configuration in which the composite heating wire 141M extends between the left and right first heating wires 141 and second heating wires 142, it is possible to provide the vehicle window glass 100 having a good temperature distribution in the wiring prohibited region 113.

In addition, the second heating wire 142 and the third heating wire 143 extend in the lateral direction on a left side of the wiring prohibited region 113 and extend in the lateral direction on a right side of the wiring prohibited region 113, the connecting portion 142S is the connecting portion 142S located on a left side of the wiring prohibited region 113 and the connecting portion 142S located on a right side of the wiring prohibited region 113, and the composite heating wire 142M of the second heating wire 142 and the third heating wire 143 connects the connecting portion 142S located on a left side of the wiring prohibited region 113 and the connecting portion 142S located on a right side of the wiring prohibited region 113, and has a section extending in the lateral direction on a lower side of the wiring prohibited region 113. In a configuration in which the composite heating wire 142M extends between the left and right second heating wire 142 and third heating wire 143, the wiring prohibited region 113 can be heated from above by the first heating wire 141 and can also be heated from below by the composite heating wire 142M. Therefore, in the configuration in which the composite heating wire 142M extends between the left and right second heating wires 142 and third heating wires 143, it is possible to provide the vehicle window glass 100 having a good temperature distribution in the wiring prohibited region 113.

Although the exemplary vehicle window glass of the present disclosure has been described above, the present disclosure is not limited to the specifically disclosed embodiment, and various modifications and changes can be made without departing from the scope of the claims.

What is claimed is:

1. A vehicle window glass comprising:
a glass plate having a wiring prohibited region; and
a defogger provided on the glass plate, wherein
the defogger includes
a pair of bus bars extending in a vertical direction of the glass plate, and
a plurality of heating wires connected between the pair of bus bars and extending in a lateral direction of the glass plate,
the glass plate includes
a first anti-fog region extending in the lateral direction between the pair of bus bars, and
a second anti-fog region formed to surround the wiring prohibited region,
the plurality of heating wires includes a first heating wire, a second heating wire, and a third heating wire provided in the second anti-fog region, and
the first heating wire and the second heating wire are connected to each other at a connecting portion located around the wiring prohibited region to form a single composite heating wire, in which the composite heating wire has a section extending in the lateral direction on an upper side of the wiring prohibited region, and the third heating wire has a section extending in the lateral direction on a lower side of the wiring prohibited region, or
the first heating wire has a section extending in the lateral direction on an upper side of the wiring prohibited region, and the second heating wire and the third heating wire are connected to each other at a connecting portion located around the wiring prohibited region to form a single composite heating wire, in which the composite heating wire has a section extending in the lateral direction on a lower side of the wiring prohibited region.

2. The vehicle window glass according to claim 1, wherein the glass plate includes a shielding film formed along an outer edge of the glass plate in a plan view,
the shielding film surrounds an outer edge of the wiring prohibited region, and
a section extending in the lateral direction on a lower side of the wiring prohibited region of the third heating wire or a section extending in the lateral direction on a lower side of the wiring prohibited region of the composite heating wire overlaps the shielding film.

3. The vehicle window glass according to claim 1, wherein the glass plate includes a shielding film formed along an outer edge of the glass plate in a plan view,
the shielding film surrounds a section on an upper side, a section on a left side, and a section on a right side among sections on the upper, lower, left, and right sides of the outer edge of the wiring prohibited region, and is not provided in a section on a lower side among the outer edge of the wiring prohibited region, and
a section extending in the lateral direction on a lower side of the wiring prohibited region of the third heating wire or a section extending in the lateral direction on a lower side of the wiring prohibited region of the composite heating wire is exposed from the shielding film.

4. The vehicle window glass according to claim 1, wherein the composite heating wires of the first heating wire and the second heating wire are thicker than portions other than the composite heating wires of the first heating wire and the second heating wire, or
the composite heating wires of the second heating wire and the third heating wire are thicker than portions other than the composite heating wires of the second heating wire and the third heating wire.

5. The vehicle window glass according to claim 2, wherein the composite heating wires of the first heating wire and the second heating wire are thicker than portions other than the composite heating wires of the first heating wire and the second heating wire, or
the composite heating wires of the second heating wire and the third heating wire are thicker than portions other than the composite heating wires of the second heating wire and the third heating wire.

6. The vehicle window glass according to claim 3, wherein the composite heating wires of the first heating wire and the second heating wire are thicker than portions other than the composite heating wires of the first heating wire and the second heating wire, or
the composite heating wires of the second heating wire and the third heating wire are thicker than portions other than the composite heating wires of the second heating wire and the third heating wire.

7. The vehicle window glass according to claim 1, wherein the composite heating wire of the first heating wire and the second heating wire is provided along a section on an upper side, a section on a left side, and a section on a right side among upper, lower, left, and right sections of an outer edge of the wiring prohibited region, and
a thickness of a portion where the composite heating wire is provided along the section on the upper side, the section on the left side, and the section on the right side is greater than that of a portion other than the composite heating wire of the first heating wire and the second heating wire.

8. The vehicle window glass according to claim 2, wherein the composite heating wire of the first heating wire and the second heating wire is provided along a section on an upper side, a section on a left side, and a section on a right side among upper, lower, left, and right sections of an outer edge of the wiring prohibited region, and
a thickness of a portion where the composite heating wire is provided along the section on the upper side, the section on the left side, and the section on the right side is greater than that of a portion other than the composite heating wire of the first heating wire and the second heating wire.

9. The vehicle window glass according to claim 3, wherein the composite heating wire of the first heating wire and the second heating wire is provided along a section on an upper side, a section on a left side, and a section on a right side among upper, lower, left, and right sections of an outer edge of the wiring prohibited region, and
a thickness of a portion where the composite heating wire is provided along the section on the upper side, the section on the left side, and the section on the right side is greater than that of a portion other than the composite heating wire of the first heating wire and the second heating wire.

10. The vehicle window glass according to claim 1, wherein the first heating wire and the second heating wire extend in the lateral direction on a left side of the wiring prohibited region and extend in the lateral direction on a right side of the wiring prohibited region,
the connecting portion is a connecting portion located on a left side of the wiring prohibited region and a connecting portion located on a right side of the wiring prohibited region, and
the composite heating wire of the first heating wire and the second heating wire connects a connecting portion located on a left side of the wiring prohibited region and a connecting portion located on a right side of the wiring prohibited region, and has a section extending in the lateral direction on an upper side of the wiring prohibited region.

11. The vehicle window glass according to claim 2, wherein the first heating wire and the second heating wire extend in the lateral direction on a left side of the wiring prohibited region and extend in the lateral direction on a right side of the wiring prohibited region,
the connecting portion is a connecting portion located on a left side of the wiring prohibited region and a connecting portion located on a right side of the wiring prohibited region, and
the composite heating wire of the first heating wire and the second heating wire connects a connecting portion located on a left side of the wiring prohibited region and a connecting portion located on a right side of the wiring prohibited region, and has a section extending in the lateral direction on an upper side of the wiring prohibited region.

12. The vehicle window glass according to claim 3, wherein the first heating wire and the second heating wire extend in the lateral direction on a left side of the wiring prohibited region and extend in the lateral direction on a right side of the wiring prohibited region,
the connecting portion is a connecting portion located on a left side of the wiring prohibited region and a connecting portion located on a right side of the wiring prohibited region, and
the composite heating wire of the first heating wire and the second heating wire connects a connecting portion located on a left side of the wiring prohibited region and a connecting portion located on a right side of the wiring prohibited region, and has a section extending in the lateral direction on an upper side of the wiring prohibited region.

13. The vehicle window glass according to claim 1, wherein the second heating wire and the third heating wire extend in the lateral direction on a left side of the wiring prohibited region and extend in the lateral direction on a right side of the wiring prohibited region,
the connecting portion is a connecting portion located on a left side of the wiring prohibited region and a connecting portion located on a right side of the wiring prohibited region, and
the composite heating wire of the second heating wire and the third heating wire connects a connecting portion located on a left side of the wiring prohibited region and a connecting portion located on a right side of the wiring prohibited region, and has a section extending in the lateral direction on an lower side of the wiring prohibited region.

14. The vehicle window glass according to claim 2, wherein the second heating wire and the third heating wire extend in the lateral direction on a left side of the wiring prohibited region and extend in the lateral direction on a right side of the wiring prohibited region,
the connecting portion is a connecting portion located on a left side of the wiring prohibited region and a connecting portion located on a right side of the wiring prohibited region, and
the composite heating wire of the second heating wire and the third heating wire connects a connecting portion located on a left side of the wiring prohibited region and a connecting portion located on a right side of the wiring prohibited region, and has a section extending in the lateral direction on an lower side of the wiring prohibited region.

15. The vehicle window glass according to claim 3, wherein the second heating wire and the third heating wire extend in the lateral direction on a left side of the wiring prohibited region and extend in the lateral direction on a right side of the wiring prohibited region,
the connecting portion is a connecting portion located on a left side of the wiring prohibited region and a connecting portion located on a right side of the wiring prohibited region, and
the composite heating wire of the second heating wire and the third heating wire connects a connecting portion located on a left side of the wiring prohibited region and a connecting portion located on a right side of the wiring prohibited region, and has a section extending in the lateral direction on an lower side of the wiring prohibited region.
